(19) United States
(12) Patent Application Publication
(10) Pub. No.: US 2016/0275252 A1
(43) Pub. Date: Sep. 22, 2016

(54) AUTOMATED CLAIMS PROCESS MANAGEMENT SYSTEM

(71) Applicant: 3M INNOVATIVE PROPERTIES COMPANY, St. Paul, MN (US)

(72) Inventors: Deborah S Anderson, Kensington, MD (US); Ankur Rawat, Aldie, VA (US); DaCosta E. Barrow, Alexandria, VA (US)

(21) Appl. No.: 15/033,913

(22) PCT Filed: Oct. 9, 2014
(86) PCT No.: PCT/US14/59806

§ 371 Date: May 3, 2016

Related U.S. Application Data
(60) Provisional application No. 61/899,953, filed on Nov. 5, 2013.

(51) Int. Cl. G06F 19/00

(52) U.S. Cl. CPC G06F 19/328

(57) ABSTRACT

Health care claims are managed and processed automatically. Data related to a plurality of health care claims is stored on a computer readable medium. The health care claims are retrieved from the computer readable medium, and each of the plurality of health care claims is assigned a type indicator with the processor from a set of type indicators that characterizes a health care service associated with each health care claim. The plurality of health care claims is then grouped based on the type indicator assigned to each of the health care claims. A programmed set of pricing rules is applied to the grouped plurality of health care claims to price each of the health care claims. The programmed set of pricing rules is derived from pricing standards for one or more health insurance systems.

### TECHNICAL FIELD

The present disclosure relates to health care information processing. More specifically, the present disclosure relates to systems and methods for automatic processing of health care claims based on programmed pricing rules.

### BACKGROUND

Healthcare costs continue to rise in developed countries and are estimated to reach over two trillion dollars a year in the U.S. alone. It is believed that as much as 25% of healthcare costs are administrative costs, as opposed to clinical costs. The costs of administering third party payment systems used in the healthcare industry are enormous. This is due, in part, to the difficulty in obtaining timely and efficient collection of payments from payment organizations (e.g., patients and third party payers, such as government agencies, insurance companies), and monitoring and maintaining payer contracts.

In most healthcare organizations, a bill or claim is generated by administrative staff from numerous departments within the healthcare organization (such as a hospital). Typically, the bill is processed in the billing department where clinical, financial, and coded data about the medical services rendered are merged together. This merging of data occurs after the healthcare services are rendered to a patient.

### SUMMARY

In one aspect, a system for automatic health care claim processing includes a computer readable medium including stored data related to a plurality of health care claims and an automated claims processor. The automated claims processor is configured to assign each of the plurality of health care claims a type indicator from a set of type indicators that characterizes a health care service associated with each health care claim, group the plurality of health care claims based on the type indicator assigned to each of the health care claims, and apply a programmed set of pricing rules to the grouped plurality of health care claims to price each of the health care claims, wherein the programmed set of pricing rules is derived from pricing standards for one or more health insurance systems. In some embodiments, the stored data on the computer readable medium includes data extracted from paper and electronically submitted health care claims. The system can further include a scanner configured to scan the paper submitted health care claims and a claims batch processor configured to convert the scanned paper submitted health care claims to electronic data related to the paper submitted health care claims and store the electronic data related to the paper submitted health care claims on the computer readable medium. The system can further include a claims batch viewing computer including a display configured to display the data related to the paper submitted health care claims and a data entry device configured to allow user entry of data missing or incorrect in the data related to the paper submitted health care claims. In some embodiments, the automated claims processor is configured to generate a plurality of prices for one or more of the health care claims based on the pricing standards for the one or more health insurance systems and identify a best price among the plurality of prices for the health care claim. The automated claims processor can be further configured to identify a preferred price (e.g., lowest price or contract price) among the plurality of prices. In some embodiments, the system further includes a user interface associated with the automated claims processor, the user interface including a display configured to display a health care claim retrieved from the computer readable medium and a user input device configured to allow editing of the retrieved health care claim. In some embodiments, the automated claims processor is further configured to identify duplicate health care claims in the plurality of health care claims.

In another aspect, in a method for health care claim processing, data related to a plurality of health care claims is stored on a computer readable medium. The plurality of health care claims are retrieved with a processor from the computer readable medium, and each of the plurality of health care claims is assigned a type indicator with the processor from a set of type indicators that characterizes a health care service associated with each health care claim. The plurality of health care claims are grouped with the processor based on the type indicator assigned to each of the health care claims. A programmed set of pricing rules is then applied with the processor to the grouped plurality of health care claims to price each of the health care claims. The programmed set of pricing rules is derived from pricing standards for one or more health insurance systems. In some embodiments, a plurality of prices is generated for one or more of the health care claims based on the pricing standards for the one or more health insurance systems. A preferred price can be determined among the plurality of prices for the one or more of the health care claims. In some embodiments, paper submitted health care claims are scanned with a scanner, the scanned paper submitted health care claims are converted to electronic data related to the paper submitted health care claims, and the electronic data related to the paper submitted health care claims is stored on the computer readable medium. In some embodiments, the data related to the paper submitted health care claims is displayed on a display, and inputs are received from a data entry device of data missing or incorrect in the data related to the paper submitted health care claims. In some embodiments, prior to assigning a type indicator, a health care claim retrieved from the computer readable medium is displayed on a user interface, and inputs are received from a user input device to edit the retrieved health care claim data. In some embodiments, duplicate health care claims are identified in the plurality of health care claims.

In a further aspect, in a method for health care claim processing, data related to a health care claim is retrieved from a computer readable medium with an automated claims processor. The data related to the health care claim is displayed on a user device associated with the automated claims processor. Inputs are received from the user device to supply data missing or incorrect in the data related to the health care claim. The health care claim is assigned a type indicator from a set of type indicators that characterizes a health care service associated with the health care claim. The health care claim is grouped with one or more other health care claims based on the type indicator assigned to the health care claim. A programmed set of pricing rules is applied with the processor to the grouped health care claims to price each of the grouped health care claims. The programmed set of pricing rules is derived from pricing standards for one or more health insurance systems. In some embodiments, inputs are received from a user device to edit the data related to the health care claim. In some embodiments, a plurality of prices is generated for the health care claim based on the pricing standards for the one or more health insurance systems. A preferred price can be identified among the plurality of prices for the health care claim and provided with provider payment information associated with the health care claim to an external claim payment processing system.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of an embodiment of a system for receiving and processing health care claims.

FIG. 2 is a block diagram of an automated claims process management system according to an embodiment of the present disclosure.

FIG. 3 is a flow diagram of an embodiment of a method for grouping and pricing health care claims in the automated claims process management system.

FIG. 4 is a flow diagram of an embodiment of a process for receiving and storing a health care claim for processing in the automated claims process management system.

FIG. 5 is a flow diagram of an embodiment of a process for assigning a claim type indicator to a health care claim in the automated claims process management system.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

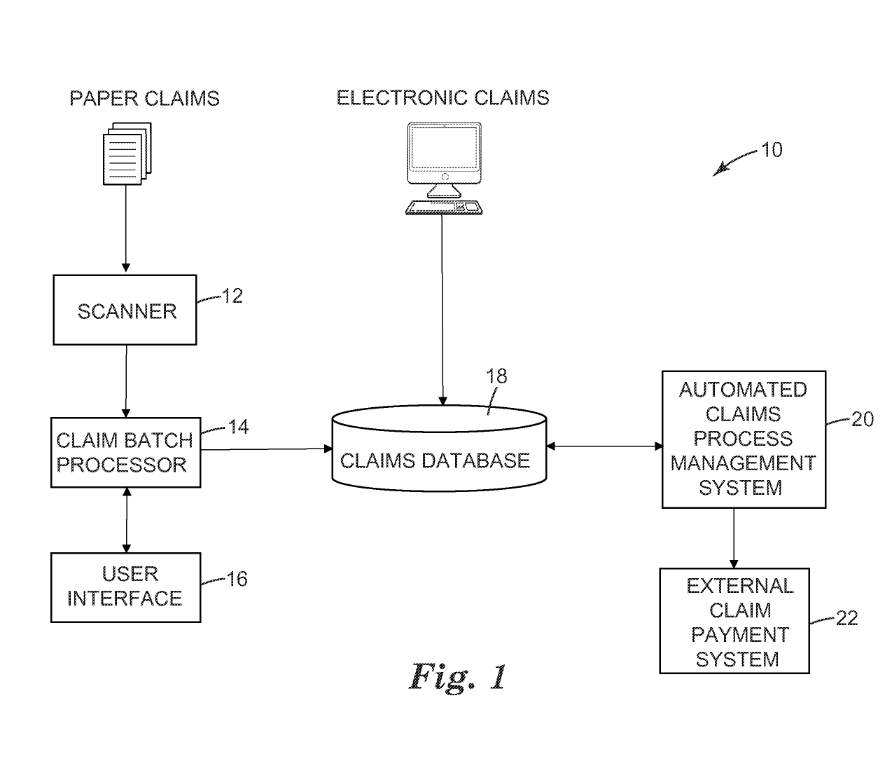

FIG. 1 is a block diagram of an embodiment of a system 10 for receiving and processing health care claims. The system 10 includes a scanner 12, a claims batch processor 14, a user interface 16, a claims database 18, an automated claims process management system 20, and an external claim payment system 22. The scanner 12 is used to scan health care claims submitted in paper form and provides an output to the claims batch processor 14. The claims batch processor 14 provides outputs to and receives inputs from the user interface 16. The claims batch processor 14 is also connected to the claims database 18. The automated claims process management system 20 communicates with the claims database 18, and provides an output to the external claim payment system 22. In some embodiments, each of the elements of the system 10 is a separate physical device or system. In other embodiments, one or more of the elements of the system 10 are combined in an integrated physical device or system. The elements of the system 10 can be configured to communicate with each other via wired or wireless communications. In some embodiments, at least some of the communications in the system 10 occur via the internet.

The scanner 12 is an image scanner configured to scan health care claims submitted in paper form by a healthcare organization or other party seeking reimbursement. The scanner 12 converts the pages of the scanned paper health care claims to digital images and provides the images to the claim batch processor 14.

The claim batch processor 14 receives the digital images of the paper submitted health care claims and processes the images to extract the data contained in the paper submitted claims. In some embodiments, the claim batch processor 14 runs optical character recognition (OCR) software on the digital images of the paper submitted claims to convert the information in the paper submitted claims to electronic data representative of the information. In some embodiments, the claim batch processor 14 is programmed to recognize the text from standardized health care claims forms, such as forms from the

Centers for Medicare and Medicaid Services (CMS) (e.g., CMS 1450, CMS 1500, etc.), the American National Standards Institute (ANSI), Accredited Standards Committee (ASC), and the Electronic Data Interchange (EDI) (e.g., X12 EDI 837, etc.). In some embodiments, the claim batch processor 14 further processes the electronic data from the scanned health care claims to automatically analyze the electronic data for accuracy and completeness. For example, the claim batch processor 14 can be configured to determine whether one or more fields in a paper submitted claim are missing or incorrect.

The claim batch processor 14 can further be configured to assemble the electronic data derived from each paper submitted health care claim into an electronic health care claim record. In some embodiments, the electronic health care claim record includes information related to the health care claim including, but not limited to, patient identification information, health insurance provider information, and medical treatment or procedure information including diagnosis codes. The claim batch processor 14 can provide this electronic health care claim record to the claims database 18 for electronic storage, or the electronic health care claim can be reviewed by a user on the user interface 16 associated with the claim batch processor 14.

The user interface 16 may be a computer in communication with, or integrated with, the claim batch processor 14. In some embodiments, the user interface includes a display configured to display information related to the electronic health care claim records generated by the claim batch processor 14, and an input device, such as a keyboard, to allow the user to edit or add information in an electronic health care claim record being reviewed on the user interface 16. For example, if the electronic health care claim record being reviewed is missing information, the user can use the keyboard to add the missing information to the electronic health care claim record. The claim batch processor 14 can be configured to alert the user on the user interface 16 when the claim batch processor 14 generates an electronic health care claim record that needs further review or editing. When an electronic health care claim record has been edited or modified on the user interface 16, the modified record can be communicated to the claim batch processor 14 for storage in the claims database 18.

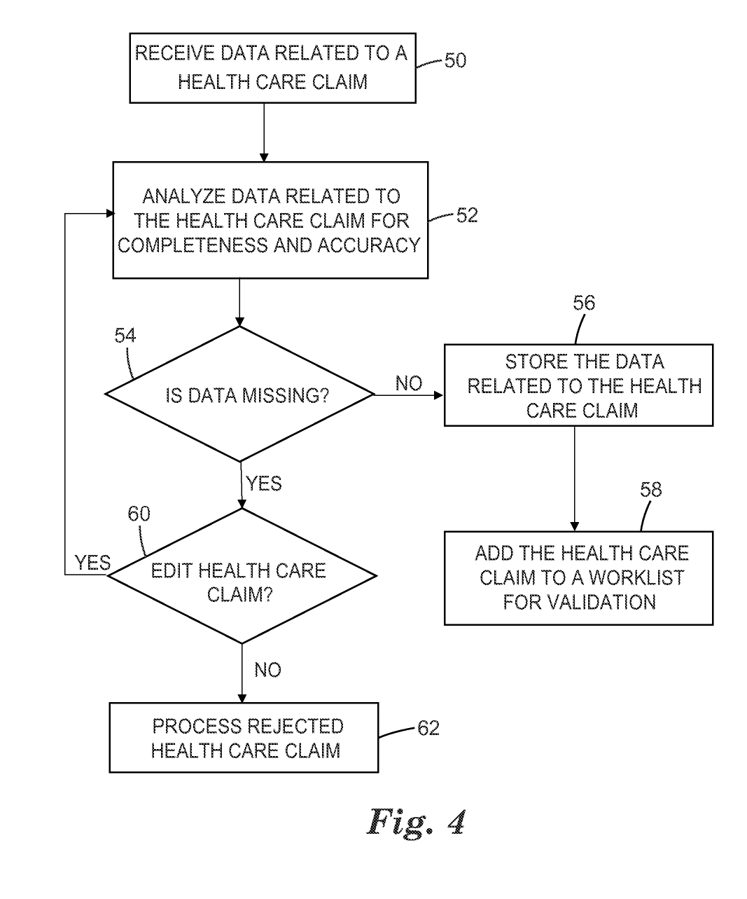

The claims database 18 is stored on a computer readable storage medium configured to store electronic health care claim records. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device. In some embodiments, the information stored in the claims database 18 is stored as a Microsoft SQL or a server (e.g., cloud) based database. The claims database 18 receives and stores the electronic health care claim records generated by the claim batch processor 14. The images generated by the scanner 12 can also be stored in the claims database 18 with its associated electronic health care claim record. An embodiment of a process for receiving, editing, and storing electronic health care claim records is described below with regard to FIG. 4.

In some embodiments, the claims database 18 is also configured to receive and store electronically submitted health care claims, as shown in FIG. 1. While a single submitting computer for the electronically submitted health care claims is shown, in actual implementation the electronically submitted health care claims are received from a plurality of submitting computers. The electronically submitted health care claims may be submitted via a computer or other electronic device from a health care organization, an administrative office associated with a health care organization, or other health care facility. In some embodiments, the electronically submitted health care claims are automatically assembled by software at the submitting organization into an electronic health care claim record for storage in the claims database 18. In other embodiments (not shown), the electronically submitted health care claims are sent to the claim batch processor 14 for further processing before being stored in the claims database 18.

The automated claims process management system 20 is configured to process the data electronic health care claim records, facilitate editing of claims, and price the health care claims associated with the records for payment. The automated claims process management system 20 provides standardized business process, data, and claims editing, and pricing functionality to meet a claim payer's specific needs for claims processing and management. Additionally, the automated claim process management system 20 applies a multi-tiered pricing approach to health care claims to determine the preferred price (e.g., lowest price or contract price) for the claim. The components and functionality of the automated claims process management system 20 will be described in more detail herein.

When a health care claim has been priced by the automated claims process management system 20, the priced claim is provided to an external claim payment system for payment. For example, the priced claim can be provided to the payer identified by the automated claims process management system 20 with the preferred price for the health insurance claim.

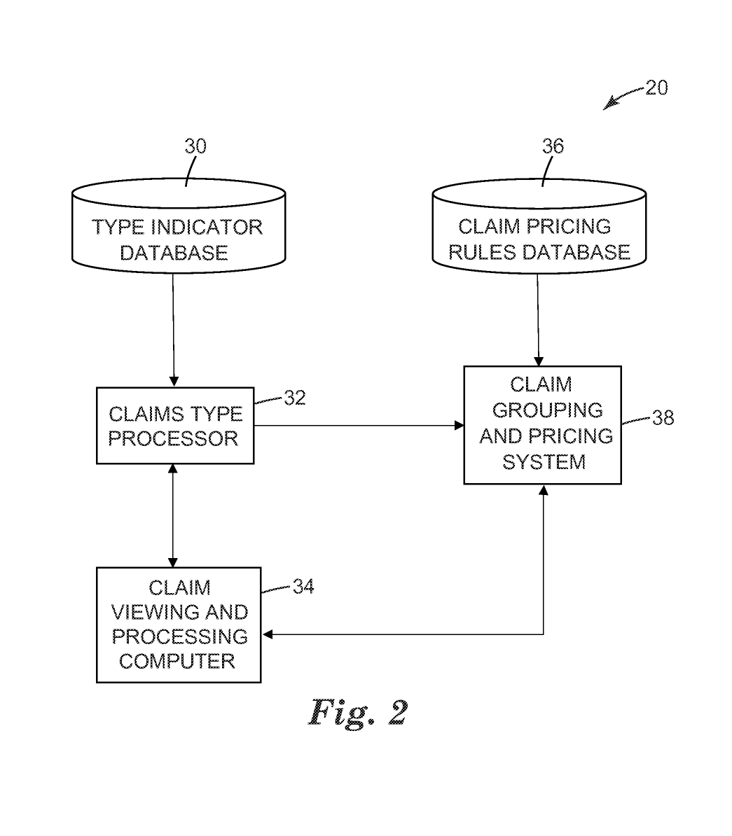

FIG. 2 is a block diagram of the automated claims process management system 20 according to an embodiment of the present disclosure. The automated claims process management system 20 includes a type indicator database 30, a claims type processor 32, a claim viewing and processing computer 34, a claim pricing rules database 36, and a claim grouping and pricing system 38. The type indicator database 30 provides inputs to the claims type processor 32, which provides outputs to the claim viewing and processing computer 34 and the claim grouping and pricing system. The claim viewing and processing computer 354 and the claim grouping and pricing system 38 communicate with each other. The claim grouping and pricing system 38 also receives an input from the claim pricing rules database 36. While the automated claims process management system 20 is shown as separate elements in FIG. 2, the elements can be integrated into a single physical system, with each of the elements implemented as software, hardware, or firmware components of the integrated system.

The type indicator database 30 can be electronically stored on a computer readable medium for access by the claims type processor. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device. The type indicator database 30 includes a plurality of type indicators usable to characterize claims retrieved from the claims database 18. The type indicators can indicate, for example, whether the claim is associated with an inpatient or outpatient procedure or episode, the duration of the procedure or episode (e.g., acute or chronic), the kind of service provided, the category of condition being treated, and/or the authorization and provider record information. In some embodiments, the type indicators stored in the type indicator database 30 are based at least in part on the forms processed by the automated claim process management system 20 and information entered on the forms. In some embodiments, the type indicator is a numeric or alphanumeric value. The type indicator database 30 can store the type indicators as a lookup table or other indexed or searchable collection.

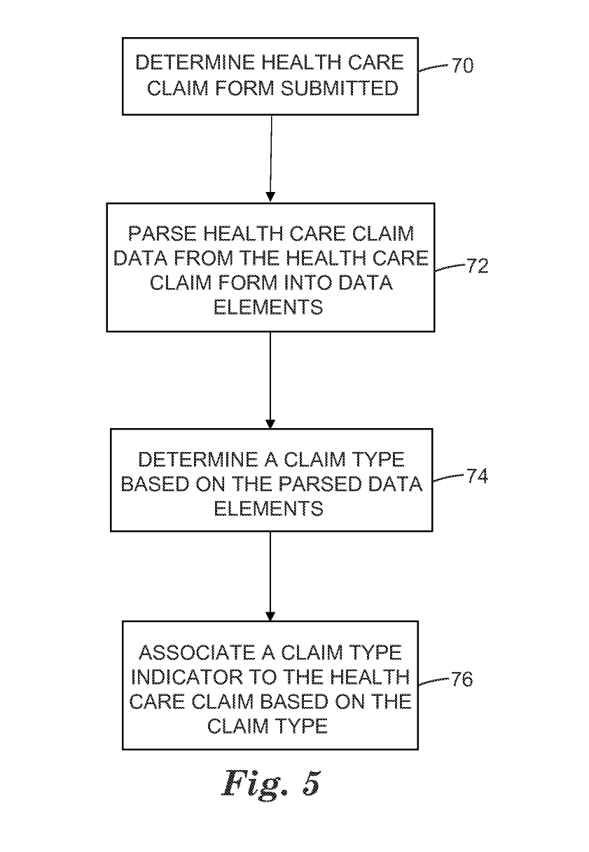

The claims type processor 32 is configured to analyze data from an electronic health care claim record and assign a claim type indicator to the associated health care claim. For example, the claims type processor 32 can be configured to determine the claim form submitted for process and parse the data in the electronic health care claim record (e.g., claim codes, provider identification number, etc.) to determine the type of claim submitted in the health care claim record. In some embodiments, the claims type processor 32 applies a programmed logic algorithm, such as a decision tree or decision table, to the parsed data to determine the claim type. The claims type processor 32 then retrieves the claim type indicator associated with the type of claim from the type indicator database 30 and assigns the claim type indicator to the electronic health care claim record. The claims type processor 32 can also format the electronic health care claim record for subsequent grouping, as will be described in more detail below. An embodiment of a process for assigning a claim type indicator with the claims type processor 32 is described below with regard to FIG. 5.

The claim viewing and processing computer 34 is configured to allow a user to validate information in an electronic health care claim record prior to forwarding the information on to the claim grouping and pricing system 38. In some embodiments, when an electronic health care claim record is added to the claims database 18, the electronic health care claim record is added to a worklist on the claim viewing and processing computer 34. The user can then select an electronic health care claim record from the worklist and validate the claim information. For example, the user can review electronic health care claim record and match the claim to an authorization and provider record of the procedure associated with the record. This assures that the claim associated with the electronic health care claim record is valid before sending the claim forward for grouping. Alternatively, the automated claims process management system 20 can be configured to validate the electronic health care claim record automatically. In some embodiments, the claim viewing and processing computer 34 includes a display to allow a user to view the information in the electronic health care claim record, and an input device, such as a keyboard, to allow the user to edit the electronic health care claim record, if necessary.

The claim pricing rules database 36 is stored on a computer readable medium, and includes provider specific rules for pricing health care claims. The claim pricing rules database 36 is accessible by the claim grouping and pricing system 38, which groups the health care claims and prices the claims based on the claim pricing rules in the claim pricing rules database 36. In some embodiments, the claim grouping and pricing system is configured to group or organize claims data from a plurality of electronic health care claim records into a set of clinically coherent episodes. The set of clinically coherent episodes can be linked, for example, by diagnosis. For episode grouping, the claim grouping and pricing system 38 builds episodes of care using all of a beneficiary's health care claims that are filed between two points in time for a specific health problem. This allows the claim grouping and pricing system 38 to then use the claim pricing rules in the claims pricing rules database 36 to determine the provider with the policy offering the lowest price for the grouped episode, or the contract price based on a business specific rule from a health plan. The pricing can depend, for example, on the services, medications, and other health care provisions for which each provider is willing to cover costs. As will be described in more detail below, the claim grouping and pricing system 38 is configured to price each grouped set of claims multiple times to determine a preferred price for the grouped claims.

The claim grouping and pricing system 38 integrates multiple industry standard groupers and reimbursement formulas and pricer tables for grouping and pricing the electronic health care claim records. In some embodiments, the user on the claim viewing and processing computer 34 can select the grouper and/or pricer algorithms to apply to electronic health care claim records. The claim grouping and pricing system 38 can be configured to include, for example, inpatient groupers and reimbursement formulas such as 3M™ (All Patient Refined Diagnosis Related Groups) APR DRGs with cost weights and trim points, AP-DRG, CMS Medicare Severity Diagnosis Related Group (MS-DRG) Inpatient Prospective Payment System, TRICARE Inpatient Prospective Payment System, New York Medicaid, New York Medicaid Managed Care, New York No-Fault, New York Worker's Compensation, Maryland All-Payer Payment using 3M™ APR DRGs, Montana Medicaid, New Jersey Medicaid, Illinois Medicaid, Indiana Medicaid, Massachusetts Blue Cross Blue Shield (BCBS), Ohio Medicaid, Pennsylvania Medicaid, Rhode Island Medicaid, Washington State Health Care Authority, Washington Medicaid, Washington Worker's Compensation, Medicare Inpatient Psychiatric Facility, Medicare Long Term Care Hospital, 3M™ Potentially Preventable Complications, 3M™ Potentially Preventable Readmissions, and/or 3M™ Inpatient Payment Calculation Toolkit. As another example, the claim grouping and pricing system 38 can be configured to include outpatient groupers and reimbursement formulas such as 3M™ Enhanced Ambulatory Patient Grouping System (EAPGS) for New York Medicaid, Maryland (all payer), Wellmark BCBS, Oklahoma BCBS, Virginia Medicaid, Medicare Ambulatory Surgical Center (ASC) Payment, Medicare Outpatient Prospective Payment System (OPPS), Medicare Renal Dialysis Facility Payment, TRICARE OPPS, 3M™ Outpatient Payment Calculation Toolkit using 3M EAPGS, and/or Medicare Physician Fee Schedule (RBRVS). The claim grouping and pricing system 38 can also be configured to include pricer tables having fee schedules associated with, for example, the Veterans Affairs (VA) Invoice Payment Processing System (IPPS), Millennium Bill, local VA pricing, Medicare Inpatient, Medicare Outpatient, TRICARE Ambulatory Payment Classifications (APC), New York Medicaid Inpatient and Outpatient, New York Medicaid/Managed Care, New York No-Fault and Workers' Compensation, Medicare Ambulatory Surgical Center, Medicare Long-Term Care Hospital, Medicare Inpatient Psychiatric Facility, Medicare Renal Dialysis Facility, and/or Medicare Professional Claims.

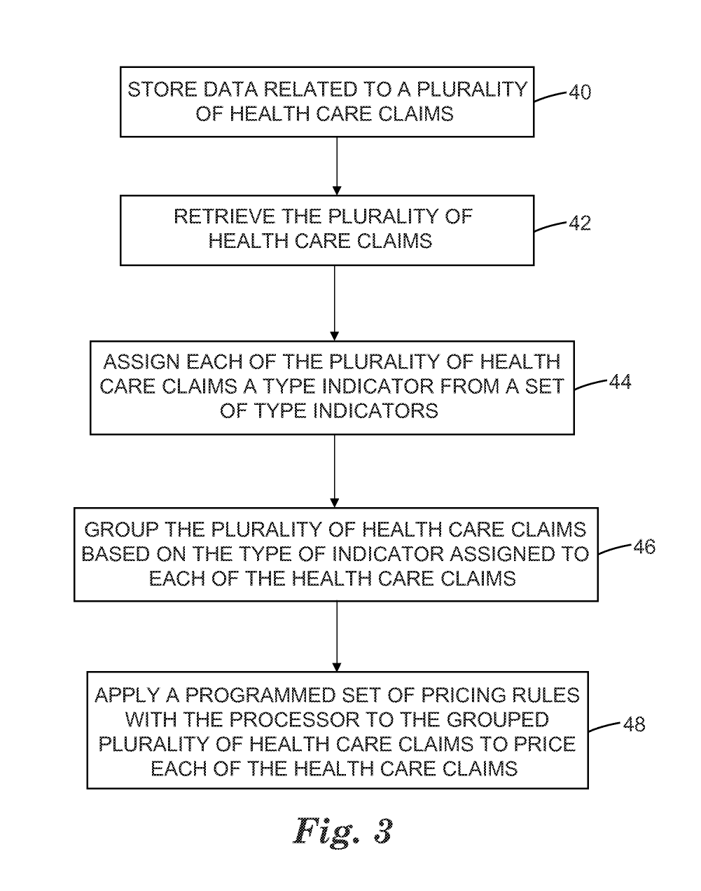

FIG. 3 is a flow diagram of an embodiment of a method for grouping and pricing health care claims in the automated claims process management system 20. In step 40, data related to plurality of health care claims is stored in the claims database 18. As discussed above, the claims database 18 can store the data as an electronic health care claim record, which is derived from paper or electronically submitted health care claims. Prior to storing the data related to the health care claims in the claim database 18, the system 10 may process the data to assure accuracy and completeness and, if necessary, provide for industry standard editing of the data for uniformity between claims. An embodiment of a process for receiving, editing, and storing submitted health care claims will be described below with regard to FIG. 4.

After storing the electronic health care claim records in the claims database 18, the health care claims appear on a worklist for validation of the information in the health care claim by a user on the claim viewing and processing computer 34. In step 42, the user retrieves a plurality of health care claims in the worklist from the claims database 18 for validation. After the information in the health care claim record is validated, the claim viewing and processing computer 34 passes the plurality of electronic health care claim records to the claim grouping and pricing system 38 for additional processing.

In step 44, the claims type processor 32 assigns each of the plurality of health care claims a claim type indicator from a set of type indicators stored in the type indicator database 30. As discussed above, the claim type indicator categorizes a health care claim based on characteristics of the health care claim. The claim type indicators can indicate, for example, whether the claim is associated with an inpatient or outpatient procedure or episode, the duration of the procedure or episode (e.g., acute or chronic), the kind of service provided, the category of condition being treated, and/or the authorization and provider record information. An embodiment of a process for assigning a claim type indicator to a health care claim is described below with regard to FIG. 5. After the claims type indicator is assigned to the health care claim, the health care claim is forwarded to the claim grouping and pricing system 38 for further processing.

In step 46, the plurality of health care claims processed by the claims type processor 32 are then grouped by the claim grouping and pricing system 38 based at least in part on the claim type indicator assigned to each claim. The claim grouping and pricing system 38 can be configured to group health care claims into groups related by episode or treatment. The claim grouping and pricing system 38 can be programmed, for example, with the types of claim data to be grouped, the time frames during which claims are to be grouped, physician attribution and benchmarking algorithms, and/or outputs to be provided to clinicians providing the treatment relative to the claim groups. The health care claims are grouped, in part, to organize the health care claims for a specific patient for pricing of the health care claims. This is useful when, for example, when a patient is being treated for multiple ailments or conditions during the time frame being processed by the claim grouping and pricing system 38. For example, the patient may be treated for at an inpatient clinic for a physical ailment and an outpatient clinic for a psychological condition during the relevant time frame, and thus would have one or more health care claims for each condition. Each of these conditions is assigned a different claim type indicator by the claims type processor 32. The claim grouping and pricing system 38 is configured to group these health care claims based on the claims type indicator so as to create separate episode groups for claims related to the physical ailment and claims related to the psychological condition. If, however, the psychological condition stems from the physical ailment, the claim grouping and pricing system 38 may group all claims related to these conditions in the same episode group.

After the health care claims have been grouped based on programmed parameters, then, in step 48, a programmed set of pricing rules stored in the claim pricing rules database 36 is applied to the grouped plurality of health care claims to price each of the health care claims. The claim pricing rules can be stored in a claim pricing database 36 accessible by the claim grouping and pricing system 38. In some embodiments, the claim pricing rules provide pricing parameters based on reimbursement plans for a plurality of insurance providers. The reimbursement plans may include payment structures for different episode types, conditions, treatments, etc., which can result in different levels of reimbursement from different insurance providers. To this end, the claim grouping and pricing system 38 is configured to price each health care claim under each health insurance provider or system under which the claim is eligible for reimbursement. The claim grouping and pricing system 38 thus can generate a plurality of different prices for each claim based on the level of reimbursement provided by each of the health insurance systems. After the claim grouping and pricing system 38 prices a claim under each eligible health insurance system, the claim grouping and pricing system 38 selects the health insurance system with the preferred reimbursement plan for payment of the claim. In some embodiments, the preferred reimbursement plan provides the lowest price to the patient for the claim. In other embodiments, the preferred reimbursement plan is a contracted price for the claim based on a business specific rule for the plan. Alternatively, the claim grouping and pricing system 38 can return all prices to the claim viewing and processing computer 34 for selection of the preferred price by a user. In any case, when the preferred price claim reimbursement is selected, the claim price and health care provider payment information are sent to a third party for processing of the claim and payment to the health care provider.

FIG. 4 is a flow diagram of an embodiment of a process for storing data related to a health care claim in the claims database 18. The process illustrated in FIG. 4 is an embodiment of step 40 in FIG. 3. In step 50, data related to a health care claim is received by the claim batch processor 14. In some embodiments, the received data related to the health care claim can be provided from paper submitted health care claim forms converted to electronic format or data derived from electronically submitted health care claims. The data related to the health care claim can include, for example, patient identification information, patient insurance provider information, health care service provider information, health care claim codes, procedure description information, and health care service description information.

In step 52, the data related to the health care claim is analyzed for completeness and accuracy. For example, the claim batch processor 14 may automatically review the electronic data associated with the health care claim to assure that all information has been included accurately in the health care claim. A user on the user interface 16 can also review the health care claim information for completeness and accuracy.

In decision step 54, the claim batch processor 14 and/or user on the user interface 16 determines whether data is missing from the health care claim. If the data is determined to be complete and accurate, then, in step 56, the data related to the health care claim is electronically stored as an electronic health care claim record in the claims database 18. As discussed above, for paper submitted claims, an electronic image of the paper submitted health care claim form (as generated by the scanner 12) can be electronically stored in the electronic health care claim record with the data related to the health care claim. When the electronic health care claim record has been stored in the claims database 18, then, in step 58, the health care claim is added to a worklist in the automated claims process management system 20 for further validation and later editing, grouping, and pricing.

If, in decision step 54, the claim batch processor 14 and/or user on the user interface 16 determines that data is missing, then, in decision step 60, it is determined whether the health care claim should be edited to supplement or correct the missing data. If the missing health care claim information can be provided by the claim batch processor 14 and/or user on the user interface 16 (e.g., missing claim codes), then the claim is edited and reanalyzed in step 52 to assure that the health care claim data is complete and accurate. In some embodiments, the claim batch processor 14 is configured to include claim coding rules and guidelines from CMS, BCBS, American Hospital Association (AHA), American Health Information Management Association (AHIMA), or American Medical Association (AMA). The claim batch processor 14 can incorporate code editing capabilities associated with industry standard edits, including, for example, the CME Outpatient Code Editor (OCE), Medicare Code Editor (MCE), National Correct Coding Initiative (NCCI), Medical Necessity edits, Present on Admission (POA) edits, Professional Claims Edits, and other edits known in the health care claim processing industry.

If the data missing (or otherwise erroneous) in the health care claim cannot be corrected by the claim batch processor 14 and/or user on the user interface 16 to place the health care claim in appropriate form for later processing, then, in step 62, the health care claim is rejected. For example, missing information that can only be supplied or corrected by the submitting party may be a cause for rejecting the health care claim. When the health care claim is rejected, a rejection letter to the submitting party may be generated by the claim batch processor 14.

FIG. 5 is a flow diagram of an embodiment of a process for assigning a claim type indicator to a health care claim in the automated claims process management system 20. The process of FIG. 5 can be performed by the claims type processor 32 discussed with regard to FIG. 2. The types of claims that may be processed by the automated claims process management system 20 includes, for example, inpatient claims, outpatient claims, professional or specialist claims, and claims related to dialysis, therapies, home health care, and contracted services.

In step 70, the claims type processor 32 determines the health care claim form used to submit the health care claim. The form used to submit the health care claim can narrow the type of claim included in a health care claim. For example, a determination of whether a claim relates to an inpatient or outpatient treatment or procedure, or whether the claim relates to treatment by a specialist, may be determined by establishing the form used to submit the health care claim. Example forms that may be submitted and categorized in this process include CMS forms, EDI and ASC forms, dental claim forms, and specialist (e.g., bowel and bladder) claim forms.

In step 72, the claims type processor 32 parses the data related to the health care claim into data elements. For example, the claim codes and health care service provider number can provide information about the type of claim submitted in the health care claim. In some embodiments, the health care service provider number is parsed into elements that provide information regarding the type of health care claim. For example, for a Medicare health care claim, the Medicare Provider Number can be parsed into separate elements to determine the claim type. Particularly the first two digits, the third character, and the suffix of the Medicare health care claim each provide information about the type of claim in the health care claim.

In step 74, after the data related to the health care claim is parsed into data elements, the claims type processor 32 determines the claim type based on the parsed data elements. The claims type processor 32 may employ, for example, a decision tree like algorithm that sequentially compares the data elements to expected values or ranges for each of the data elements to establish the type of claim in the health care claim. The decision tree can process each data element relevant to determining the type of claim until a claim type is established. In some embodiments, if the claims type processor 32 is not able to determine the claim type from the data elements, the claims type processor 32 may determine that data in the health care claim is invalid and send the health care claim to the submitter for correction.

In step 76, after the type of claim has been determined by the claims type processor 32, the claim type processor 32 associates a claim type indicator to the health care claim based on the claim type. The claim type processor 32 can retrieve the claim type indicator from the type indicator database 30. As discussed above, the claim type indicator categorizes a health care claim based on various characteristics, such as whether the claim is associated with an inpatient or outpatient procedure or episode, the duration of the procedure or episode (e.g., acute or chronic), the kind of service provided, the category of condition being treated, and/or the authorization and provider record information. The claim type indicator can be, for example, numeric or alphanumeric. When the claim type indicator has been assigned to the health care claim, the claim can be forwarded for grouping and pricing as described above.

The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

We claim:

1. A system for automatic health care claim processing, the system comprising
a computer readable medium including stored data related to a plurality of health care claims; and
an automated claims processor configured to assign each of the plurality of health care claims a type indicator from a set of type indicators that characterizes a health care service associated with each health care claim, group the plurality of health care claims based on the type indicator assigned to each of the health care claims, and apply a programmed set of pricing rules to the grouped plurality of health care claims to price each of the health care claims, wherein the programmed set of pricing rules is derived from pricing standards for one or more health insurance systems.

2. The system of claim 1, wherein the stored data on the computer readable medium includes data extracted from paper and electronically submitted health care claims.

3. The system of claim 2, and further comprising:
a scanner configured to scan the paper submitted health care claims; and
a claims batch processor configured to convert the scanned paper submitted health care claims to electronic data related to the paper submitted health care claims and store the electronic data related to the paper submitted health care claims on the computer readable medium.

4. The system of claim 3, and further comprising:
a claims batch viewing computer including a display configured to display the data related to the paper submitted health care claims and a data entry device configured to allow user entry of data missing or incorrect in the data related to the paper submitted health care claims.

5. The system of claim 1, wherein the automated claims processor is configured to generate a plurality of prices for one or more of the health care claims based on the pricing standards for the one or more health insurance systems.

6. The system of claim 5, wherein the automated claims processor is further configured to identify a lowest price among the plurality of prices.

7. The system of claim 1, and further comprising:
a user interface associated with the automated claims processor, the user interface including a display configured to display a health care claim retrieved from the computer readable medium and a user input device configured to allow editing of the retrieved health care claim.

8. The system of claim 1, wherein the automated claims processor is further configured to identify duplicate health care claims in the plurality of health care claims.

9. A method for health care claim processing, the method comprising:
storing data related to a plurality of health care claims on a computer readable medium;
retrieving the plurality of health care claims with a processor from the computer readable medium;
assigning each of the plurality of health care claims a type indicator with the processor from a set of type indicators that characterizes a health care service associated with each health care claim;
grouping the plurality of health care claims with the processor based on the type indicator assigned to each of the health care claims; and
applying a programmed set of pricing rules with the processor to the grouped plurality of health care claims to price each of the health care claims, wherein the programmed set of pricing rules is derived from pricing standards for one or more health insurance systems.

10. The method of claim 9, wherein the applying step comprises:
generating a plurality of prices for one or more of the health care claims based on the pricing standards for the one or more health insurance systems.

11. The method of claim 10, and further comprising:
identifying a lowest price with the processor among the plurality of prices for the one or more of the health care claims.

12. The method of claim 9, wherein the storing step comprises:
scanning paper submitted health care claims with a scanner; and
converting the scanned paper submitted health care claims to electronic data related to the paper submitted health care claims; and
storing the electronic data related to the paper submitted health care claims on the computer readable medium.

13. The method of claim 12, and further comprising:
displaying the data related to the paper submitted health care claims on a display; and
receiving inputs from a data entry device of data missing or incorrect in the data related to the paper submitted health care claims.

14. The method of claim 9, wherein prior to the assigning step, the method further comprises:
displaying a health care claim retrieved from the computer readable medium on a user interface; and
receiving inputs from a user input device to edit the retrieved health care claim data.

15. The method of claim 9, and further comprising:
identifying with the processor duplicate health care claims in the plurality of health care claims.

16. A method for health care claim processing, the method comprising:
retrieving data related to a health care claim from a computer readable medium with an automated claims processor;
displaying the data related to the health care claim on a user device associated with the automated claims processor;
receiving inputs from the user device to supply data missing or incorrect in the data related to the health care claim;
assigning the health care claim a type indicator from a set of type indicators that characterizes a health care service associated with the health care claim;
grouping the health care claim with one or more other health care claims based on the type indicator assigned to the health care claim; and
applying a programmed set of pricing rules with the processor to the grouped health care claims to price each of the grouped health care claims, wherein the programmed set of pricing rules is derived from pricing standards for one or more health insurance systems.

17. The method of claim 16, wherein the receiving step further comprises receiving inputs from a user device to edit the data related to the health care claim.

18. The method of claim 16, wherein the applying step comprises:
generating a plurality of prices for the health care claim based on the pricing standards for the one or more health insurance systems.

19. The method of claim 18, and further comprising:
identifying a lowest price with the processor among the plurality of prices for the health care claim.

20. The method of claim 19, and further comprising:
providing the lowest price for the health care claim and provider payment information associated with the health care claim to an external claim payment processing system.
